(19) United States
(12) Patent Application Publication
(10) Pub. No.: US 2026/0066956 A1
(43) Pub. Date: Mar. 5, 2026

(54) OVERHEAD ALLOCATION FOR MACHINE LEARNING BASED CSI FEEDBACK

(71) Applicant: APPLE INC., Cupertino, CA (US)

(72) Inventors: Weidong Yang, San Diego, CA (US); Huaning Niu, San Jose, CA (US); Wei Zeng, San Diego, CA (US); Oghenekome Oteri, San Diego, CA (US); Dawei Zhang, Saratoga, CA (US); Chunxuan Ye, San Diego, CA (US)

(21) Appl. No.: 19/106,923

(22) PCT Filed: Sep. 11, 2023
(86) PCT No.: PCT/US2023/073840

§ 371 Date: Feb. 26, 2025

Related U.S. Application Data
(60) Provisional application No. 63/376,990, filed on Sep. 23, 2022.

(51) Int. Cl. H04B 7/0417; H04B 7/0456; H04B 7/06; H04L 5/00

(52) U.S. Cl. CPC H04B 7/0417; H04B 7/0486; H04L 5/0053; H04L 5/0094; H04B 7/0626; H04B 7/0658

(57) ABSTRACT

Methods and apparatus are provided machine learning (ML) based channel state information (CSI) feedback from a user equipment (UE) to a wireless network. For a neural network (NN) model type and an approach for deriving CSI for multiple rank CSI feedback, the UE reports one or more feedback size in a UE capability message to the wireless network. For the NN model type and the approach, the UE processes a configuration from the wireless network of a plurality of NN models associated with the one or more feedback size. The UE processes an overhead allocation for the one or more feedback size and generates the multiple rank CSI feedback using different NN models of the plurality of NN models, per spatial layer or spatial layer group or rank, based on the overhead allocation.

### TECHNICAL FIELD

This application relates generally to wireless communication systems, including channel state information (CSI) feedback.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-FiR).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC)

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an encoder and a decoder in a CSI feedback operation according to certain embodiments.

FIG. 2 illustrates a table of average cosine similarity between different spatial layers for different codebook configurations.

FIG. 3 is a table describing four neural network model categories.

FIG. 4A illustrates three approaches that may be used with embodiments disclosed herein to derive CSI for multiple rank CSI feedback.

FIG. 4B illustrates another approach comprising spatial layer group common neural network models that may be used with embodiments disclosed herein.

FIG. 5 is a flowchart of a method for overhead allocation for ML based CSI feedback according to one embodiment.

FIG. 6 is a flowchart of a method for overhead allocation for ML based CSI feedback according to another embodiment.

FIG. 7 is a flow chart of a method for a UE to provide ML based CSI feedback to a wireless network according to one embodiment.

FIG. 8 is a flowchart of a method for a base station to configure ML based CSI feedback in a wireless network according to one embodiment.

FIG. 9 illustrates an example architecture of a wireless communication system, according to embodiments disclosed herein.

FIG. 10 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Downlink CSI (e.g., for frequency division duplex (FDD) operation) may be sent from a UE to a base station through feedback channels. The base station may use the CSI feedback, for example, to reduce interference and increase throughput for massive multiple-input multiple-output (MIMO) communication. However, such feedback uses excessive overhead. Vector quantization or codebook-based feedback may be used to reduce feedback overhead. The feedback quantities resulting from these approaches. however, are scaled linearly with the number of transmit antennas, which may be difficult when hundreds or thousands of centralized or distributed transmit antennas are used.

Artificial intelligence (AI) and/or machine learning (ML) may be used for CSI feedback enhancement to reduce overhead, improve accuracy, and/or generate predictions. AI and/or ML may also be used, for example, for beam management (e.g., beam prediction in time/spatial domain for overhead and latency reduction and beam selection accuracy improvement) and/or positioning accuracy enhancements.

CSI feedback using AI and/or ML may be formulated as a joint optimization of an encoder and a decoder. See, e.g., Chao-Kai Wen, Wan-Ting Shih, and Shi Jin, “Deep Learning for Massive MIMO CSI Feedback,” IEEE Wireless Communications Letters, Volume 7, Issue 5, October 2018. Since this early paper by Chao-Kai Wen, et al., auto-encoders and many variations have been considered. Image processing/video processing technology have been used for CSI compression, which can be natural choices considering the latest wave of ML applications in image processing/video processing. Further, when formulated in the right domain, CSI feedback bears similarities to images/video streams.

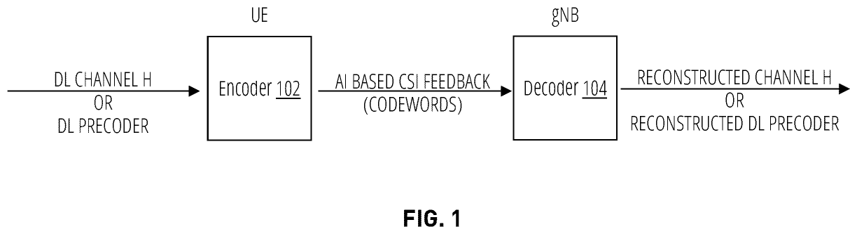

At a high level, FIG. 1 illustrates an encoder 102 of a UE and a decoder 104 of a base station (e.g., gNB) in an AI based CSI feedback operation according to certain embodiments. As shown, the encoder 102 receives a downlink (DL) channel H or a DL precoder and outputs AI based CSI feedback. The encoder 102 learns a transformation from original transformation matrices to compressed representations (codewords) through training data. The decoder 104 learns an inverse transformation from the codewords to the original channels. Thus, the decoder 104 can receive the AI based CSI feedback (codewords) from the encoder 102 and output a reconstructed channel H or DL precoder (which can be denoted by H). End-to-end learning (e.g., with an unsupervised learning algorithm) may be used to train the encoder 102 and the decoder 104. Typically. normalized mean square error (NMSE) or cosine similarity is the optimization metric. In some designs, the DL channel H can be replaced with DL precoder. Hence, the encoder 102 takes the DL precoder as input and generates AI based CSI feedback and the decoder 104 takes the AI based CSI feedback and reconstructs the DL precoder.

Various types of neural network (NN) encoders/decoders can be trained for different purposes, with different tradeoffs of complexity, overhead, and performance. A convolutional neural network (CNN) may, for example, be used for CSI feedback for frequency and spatial domain CSI reference signal (CSI-RS) compression. Other examples include using a transformer or a generative adversarial network (GAN). Depending on number of receive antennas and rank, either channel feedback or precoding matrix feedback can be used. For example, with four receive antennas, rank 1 and rank 2 feedback may potentially use AI NN trained with eigenvectors as input. whereas rank 3 and rank 4 can potentially use a channel matrix as input to a trained AI NN. Data preprocessing can be used on input of an AI model. Preprocessing from frequency domain to time domain may be used and some of the small paths may be removed before input to the AI NN. A maximum rank indicates a maximum number of layers per UE, which corresponds to a lack of correlation or interference between the UE's antennas. For example, rank 1 corresponds to a maximum of one spatial layer for the UE, rank 2 corresponds to a maximum of two spatial layers for the UE, rank 3 corresponds to a maximum of three layers for the UE, and rank 4 corresponds to a maximum of four layers for the UE.

CNN+RNN (recurrent NN) based NN may be used for time domain, frequency domain, and spatial domain CSI-RS compression. The input may be a time sequence with a set of CSI-RS configurations. A preprocessed time sequence such as frequency domain pre-processing (to time domain and removing small channel taps), and Doppler domain preprocessing can also be applied as AI input. Angular domain preprocessing is also possible, however, angular domain preprocessing may not be efficient in certain implementations.

### Channel Description

For a wireless channel, between a base station (e.g., gNB) and a UE, the highest few singular values of the channel matrix or the wideband covariance matrix tend to be much larger than the rest singular values. For example, a precoder may be obtained using a singular value decomposition of the channel matrix H=U S V, where for 32 transmit antennas at the base station and 4 receive antennas at the UE, H is a 4×32 matrix, V is 32×32 matrix, U is a 4×4 matrix, and S is a 4×32 matrix. The channel may not support full rank transmission. Thus, the singular values along a diagonal of the S matrix may be arranged from largest to smallest. As shown in the following example S matrix, the largest singular value may be much larger than the rest of the singular values along the diagonal:

$$S = [ \begin{matrix}8.2246 & 0 & 0 & 0 \\ 0 & 2.5371 & 0 & 0 \\ 0 & 0 & 2.2651 & 0 \\ 0 & 0 & 0 & 1.9626\end{matrix} ] .$$

Further, from the strongest spatial layers, typically a compact or parsimonious representation may be enough, since they can be well represented by a few clusters with significant power. The V matrix may be represented as 32 column vectors (V=[v1, . . . , v32]. A vector v1 corresponding to spatial layer 1, for example, can be easily represented because it corresponds to a dominant angle of departure. Thus, vector v1 has a clear physical meaning and can be described in a compact way. For other spatial layers (e.g., layer 3 and layer 4), however, this may not be the case because the singular value decomposition may include leakage from the strongest angle of departure and weaker signals from other angles of departure. That is to say, there may be contributions from weaker clusters.

In the precoder calculation, it may also be observed that the higher rank's precoder is susceptible to subspace rotation. Hence, the physics motivated representation for the higher rank's (e.g., rank 3 and rank 4) precoder may have more problems to work than for a lower rank's (ranks 1 and rank 2) precoder.

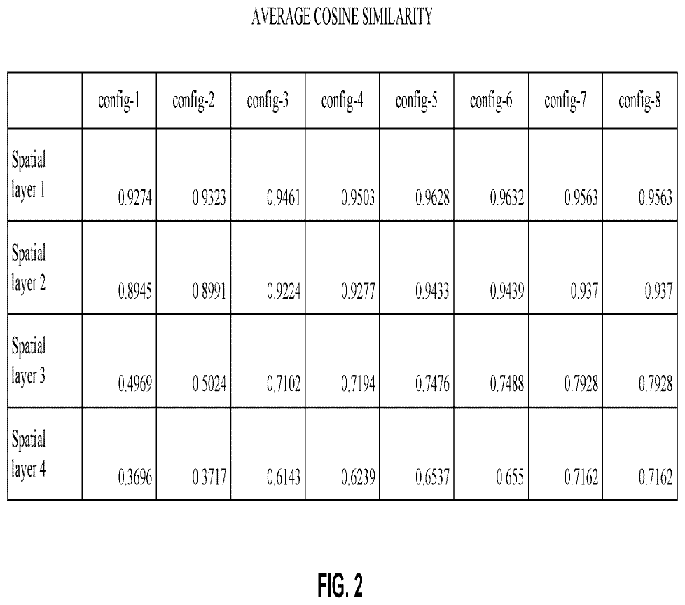

By way of example, FIG. 2 illustrates a table of average cosine similarity between different spatial layers (spatial layer 1, spatial layer 2, spatial layer 3, and spatial layer 4) for different NR Release 16 (Rel. 16) Type II codebook configurations (confi-1, confi-2, confi-3, confi-4, confi-5, confi-6, confi-7, confi-8). The feedback overhead increases with the configuration value. Thus, Type II codebook configuration 1 (config-1) uses the lowest feedback overhead and Type II codebook configuration 8 (config-8) uses the highest feedback overhead. An average cosine similarity near or above 0.9 may be considered to have low quantization error, whereas lower average cosine similarity values correspond to high quantization errors. Thus, for example, Type II codebook configuration 1 (config-1) with low feedback overhead has a good average cosine similarity for spatial layer 1 (0.9274), but poor average cosine similarity for spatial layer 3 (0.4969) and spatial layer 4 (0.3696). As shown, spatial layer 1 and spatial layer 2 have relatively good average cosine similarity values for each of the Type II codebook configurations. Spatial layer 3 and spatial layer 4, however, benefit from increasing feedback overhead at the higher Type II codebook configurations (e.g., the average cosine similarity increases for spatial layer 3 to 0.7928 and for spatial layer 4 to 0.7162). Thus, the amount of benefit of increasing feedback overhead depends on the spatial layer.

### NN Model Types and Approaches

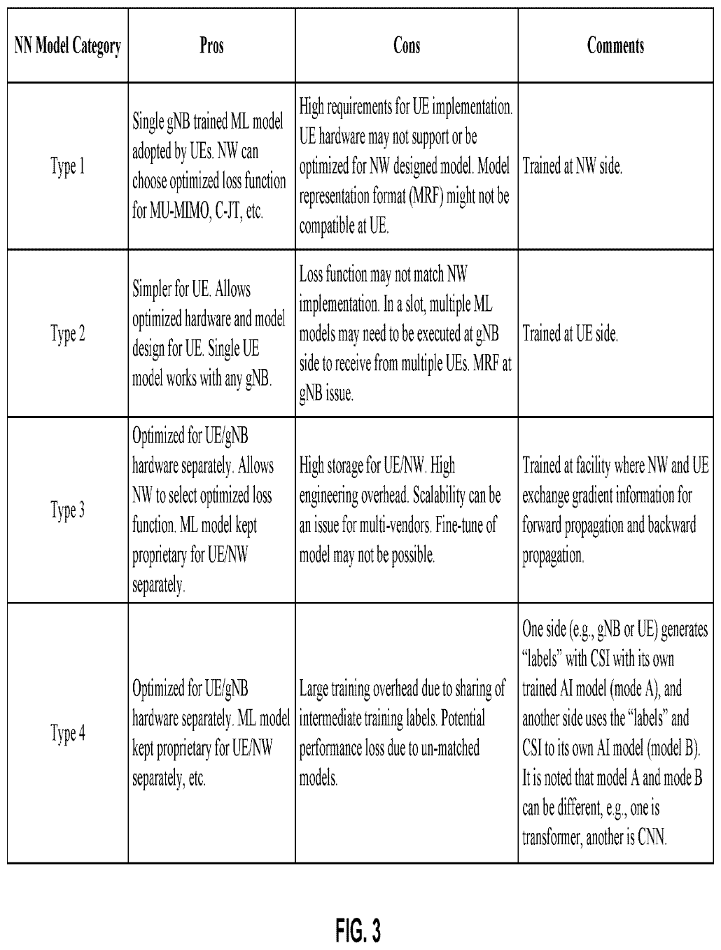

Generally, there may be multiple NN model types and various approaches to derive CSI for multiple rank CSI feedback. For example, FIG. 3 illustrates a table describing a general categorization of NN models that may be used with certain embodiments. In particular, FIG. 3 is a table describing four NN model categories, which may be referred to herein as Type 1, Type 2, Type 3, and Type 4.

NN model Type 1 comprises a single network-side (e.g., gNB) trained ML model adopted by UEs. A network (NW) can choose an optimized loss function for multi user MIMO (MU-MIMO), coherent joint transmission (C-JT), etc. However, NN model Type 1 may have high requirements for UE implementation. For example, UE hardware may not support and/or be optimized for the NW designed model. Further, a model representation format (MRF) might not compatible at the UE.

NN model Type 2 comprises a UE-side trained ML model that may be simpler for the UE and may allow an optimized hardware and model design for the UE. A single UE model may work with any base station (gNB). However, the loss function may not match NW implementation. In a slot, multiple ML models may need to be executed at the gNB side to receive from multiple UEs. MRF at the gNB may be issue.

NN model Type 3 is optimized for UE and base station (e.g., gNB) hardware separately, and the NW is allowed to select the optimized loss function. The ML model may be kept proprietary for UE/NW separately. However, NN model Type 3 may use a high amount of storage for the UE and/or NW. Scalability may also be an issue for multi-vendors. Further, fine-tuning of the model may not be possible. The NN model Type 3 may be trained at a facility where the NW and the UE exchange gradient information for forward propagation and backward propagation.

NN model Type 4 is optimized for UE and base station (e.g., gNB) hardware separately. The ML model may be kept proprietary for UE/NW separately. However, NN model Type 4 may use a large training overhead due to sharing of intermediate training labels. Further, there is a potential performance loss due to un-matched models. For training, one side (e.g., gNB or UE) generates “labels” with CSI for its own trained AI model (mode A), and the other side provides the “labels” and CSI to its own AI model (model B). It is noted that model A and mode B can be different (e.g., one model may be a transformer and the other model may be a CNN).

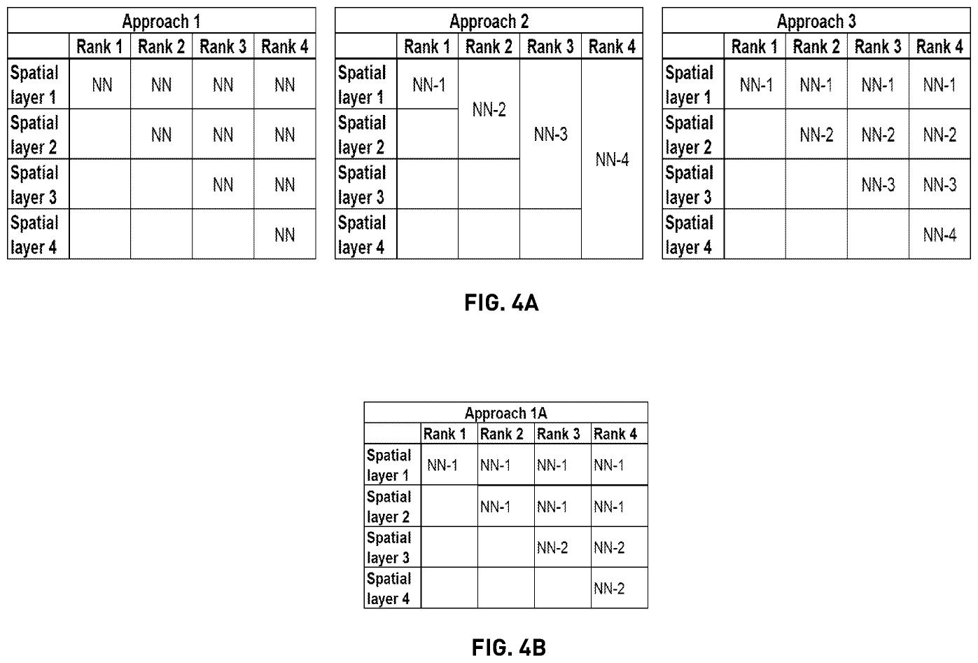

FIG. 4A illustrates three approaches that may be used with embodiments disclosed herein to derive CSI for multiple rank CSI feedback. A first approach (Approach 1) comprises using a spatial layer common NN model. As shown, in Approach 1, the same single rank NN model is used for each spatial layer (spatial layer 1, spatial layer 2, spatial layer 3, and spatial layer 4) to derive the precoder for each spatial layer.

A second approach (Approach 2) comprises using rank-specific NN models. As shown in FIG. 4A, for example, if the maximum rank is limited to four, then there are four NN models (NN-1, NN-2, NN-3, and NN-4). A first NN model (NN-1) is used for rank 1 corresponding to spatial layer 1. A second NN model (NN-2) is used for rank 2 corresponding to spatial layer 1 and spatial layer 2. A third NN model (NN-3) is used for rank 3 corresponding to spatial layer 1, spatial layer 2, and spatial layer 3. A fourth NN model (NN-4) is used for rank 4 corresponding to spatial layer 1, spatial layer 2, spatial layer 3, and spatial layer 4.

A third approach, (Approach 3) comprises using spatial layer specific NN models. As shown in FIG. 4A, for example, if the maximum rank limited to four, then there are four NN models (NN-1, NN-2, NN-3, and NN-4). A first NN model (NN-1) is used for spatial layer 1 for rank 1, rank 2, rank 3, and rank 4. A second NN model (NN-2) is used for spatial layer 2 for rank 2, rank 3, and rank 4. A third NN model (NN-3) is used for spatial layer 3 for rank 3 and rank 4. A fourth NN model (NN-4) is used for spatial layer 4 for rank 4.

In certain embodiments, other approaches may also be used to derive CSI for multiple rank CSI feedback. For example, spatial layer group and/or rank group specific approaches may be used. FIG. 4B, for example, illustrates another approach (Approach 1A) comprising spatial layer group common NN models according to one embodiment. In the illustrated example, four spatial layers are divided into two spatial layer groups. A first NN model (NN-1) is used for a first spatial layer group including spatial layer 1 and spatial layer 2. A second NN model (NN-2) is used for a second spatial layer group including spatial layer 3 and spatial layer 4.

For NN model Type 1 and NN model Type 2, one or more NN models may be deployed or configured at the UE and the NW. The encoder of a NN model resides at the UE and the decoder of the NN model resides at the NW. For approach 1, a single NN model is deployed or configured for the UE and NW. For Approaches 1A, 2, and 3, there may be multiple NN models deployed or configured for the UE and NW.

For NN model Type 3 and NN model Type 4, because a UE-side NN model is trained or optimized separately at the UE from a NW-side NN model, one or more NN model pairs may be deployed at the UE and the NW. The encoder of a UE-side NN model resides at the UE. The decoder of a NW-side NN model, which is the counterpart of the UE-side NN model, resides at the NW. For approach 1, a single NN model pair is deployed or configured for the UE and NW. For Approaches 1A, 2, and 3, there may be multiple NN model pairs deployed or configured for the UE and NW.

In certain embodiments, the NW may configure the UE with one or more NN model (or model pair) corresponding to a number of different feedback overhead sizes. Alternatively, from another perspective, the number of NN models is not increased. Rather, the feedback overhead size is considered a property of the NN model. For example, the NN model in Approach I may be associated with 30 bits or 60 bits. As further examples, in Approach 2. NN-3 may be associated with 80 bits or 100 bits, and/or NN-4 may be associated with 120 bits or 240 bits.

### Selective Feedback Overhead per Rank, Spatial Layer or Spatial Layer Group

In certain embodiments, the feedback overhead for different ranks, spatial layers, or spatial layer groups may not be the same for AI-motivated CSI feedback. In one such embodiment, the overhead allocation may be configured by the base station (e.g., gNB). The base station may explicitly indicate the overhead allocation for different spatial layers to the UE. For example, the base station may indicate 40 bits allocated for each of spatial layer 1 and spatial layer 2, and 60 bits allocated for each of spatial layer 3 and spatial layer 4. The UE then inputs spatial layer 1 information into a first model associated with a feedback overhead of 40 bits, inputs spatial layer 2 information into the first model associated with the feedback overhead of 40 bits, inputs spatial layer 3 information into a second model associated with a feedback overhead of 60 bits, and inputs spatial layer 4 information into the second model associated with the feedback overhead of 60 bits. Thus, the total feedback overhead in this example is 40 bits+40 bits+60 bits+60 bits=200 bits. In another embodiment, the base station indicates a ratio among feedback overhead for each spatial layer to the UE and a total number of feedback bits. In yet another embodiment, the base station indicates a ratio among spatial layer groups to the UE.

In other embodiments, the overhead allocation is selected and reported by the UE to the base station. For example, the UE can allocate 40 bits for each of spatial layer 1 and spatial layer 2, and the UE can allocate 60 bits for each of spatial layer 3 and spatial layer 4. The UE reports the overhead allocation numbers for each spatial layer in a CSI report or the UE reports the feedback overhead for at least two groups of spatial layers in CSI feedback. The UE may report the ratio of feedback overhead between at least two groups of spatial ranks. For example, the UE may report that the feedback overhead for {rank1, rank2} is ¾ of the feedback overhead for {rank 3, rank 4}.

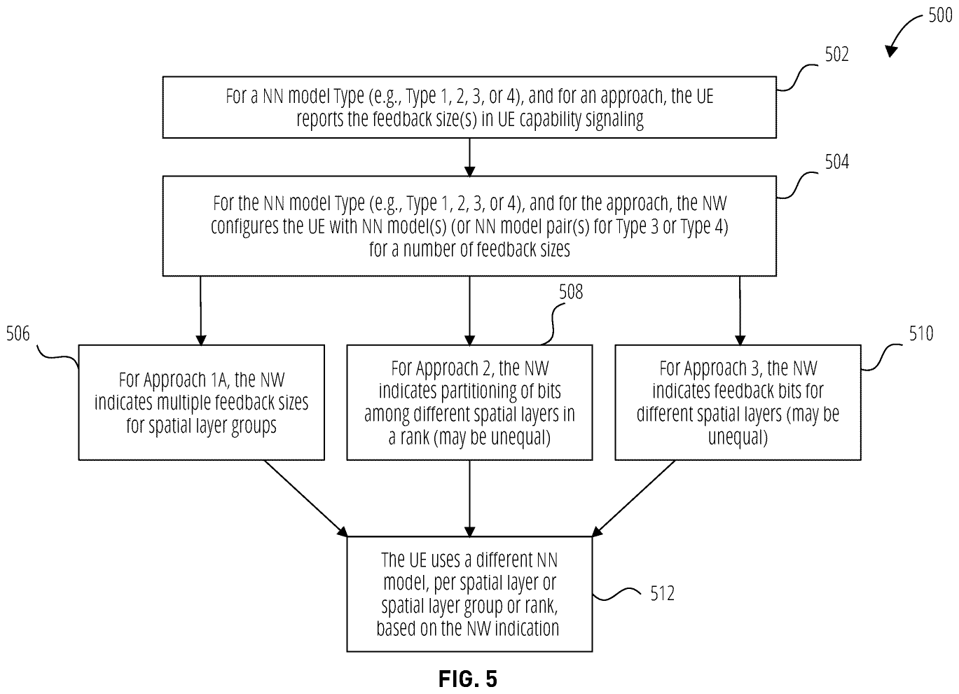

FIG. 5 is a flowchart of a method 500 for overhead allocation for ML based CSI feedback according to one embodiment. At block 502, for a NN model Type (.e.g., Type 1, 2, 3, or 4), and for an approach, the UE reports preferred or capable feedback size(s) in UE capability signaling. At block 504, for the NN model Type (.e.g., Type 1, 2, 3, or 4), and for the approach, the NW configures the UE with NN model(s) (or NN model pair(s) for Type 3 or Type 4) for a number of feedback sizes according to the reported feedback size(s) from the UE. In block 506, block 508, or block 510, depending on the approach, the NW indicates the overhead allocation to the UE. In block 512, the UE uses a different NN model, per spatial layer or spatial layer group or rank, based on the NW indication of the overhead allocation. FIG. 5 shows example NW indications for Approach 1A (block 506), Approach 2 (block 508), and Approach 3 (block 510). However, the disclosure is not so limited, and NW indications may also be applied to other approaches to derive CSI for multiple rank CSI feedback.

As shown in block 506, when the approach comprises Approach 1A discussed above, the NW indicates multiple feedback sizes for spatial layer groups. Referring to FIG. 4B, the NW may indicate a first feedback size for a first spatial layer group that includes spatial layer 1 and spatial layer 2, and the NW may indicate a second feedback size for a second spatial layer group that includes spatial layer 3 and spatial layer 4. Alternatively, the NW may indicate the total feedback size and a ratio of an allocated feedback size to the total feedback size for each spatial layer group. At block 512 of the method 500, the UE uses a first NN model (NN-1) associated with the first feedback size indicated by the NW for spatial layer 1 (for rank 1, rank 2, rank 3, and rank 4) and spatial layer 2 (for rank 2, rank 3, and rank 4). The UE also uses a second NN model (NN-2) associated with the second feedback size indicated by the NW for spatial layer 3 (for rank 3 and rank 4) and spatial layer 4 (for rank 4).

As shown in block 508, when the approach comprises Approach 2 discussed above, the NW indicates partitioning of bits among different spatial layers in a rank (wherein the partitioning may be unequal). Referring to Approach 2 shown in FIG. 4A, for example, the NW may indicate to use a first number of feedback bits (e.g., 30 bits) for spatial layer 1 in rank 1. For rank 2, the NW may indicate to use a second number of feedback bits (e.g., 60 bits) partitioned between spatial layer 1 and spatial layer 2. For rank 3, the NW may indicate to use a third number of feedback bits (e.g., 120 bits) partitioned between spatial layer 1. spatial layer 2. and spatial layer 3 in rank 3. By way of example, for rank 3, the NW may indicate to use 30 bits for each of spatial layer 1 and spatial layer 2 and 60 bits for spatial layer 3. For rank 4, the NW may indicate to use a fourth number of feedback bits (e.g., 240 bits) partitioned between spatial layer 1, spatial layer 2, spatial layer 3, and spatial layer 4. By way of example, for rank 4, the NW may indicate to use 30 bits for each of spatial layer 1 and spatial layer 2, 60 bits for spatial layer 3, and 120 bits for spatial layer 4. Skilled persons will recognize from the disclosure herein, however, that any partitioning may be used for rank 2, rank 3, or rank 4, including equal partitioning among the spatial layers. Alternatively, the NW may indicate the total number of feedback bits and a ratio of allocated bits to the total number of feedback bits for each spatial layer. At block 512 of the method 500, the UE uses a first NN model (NN-1) associated with the first number of feedback bits indicated by the NW for rank 1 (spatial layer 1), a second NN model (NN-2) associated with the second number of feedback bits indicated by the NW for rank 2 (spatial layer 1 and spatial layer 2), a third NN model (NN-3) associated with the third number of feedback bits indicated by the NW for rank 3 (spatial layer 1, spatial layer 2, and spatial layer 3), and a fourth NN model (NN-4) associated with the fourth number of feedback bits indicated by the NW for rank 4 (spatial layer 1, spatial layer 2, spatial layer 3, and spatial layer 4).

As shown in block 510, when the approach comprises Approach 3 discussed above, the NW indicates feedback bits for different spatial layers (wherein the number of feedback bits per spatial layer may be unequal). Referring to Approach 3 shown in FIG. 4A, for example, the NW may indicate to use a first number of feedback bits (e.g., 30 bits) for spatial layer 1 in rank 1, rank 2, rank 3, and rank 4. The NW may indicate to use a second number of feedback bits (e.g., 30 bits) for spatial layer 2 in rank 2, rank 3, and rank 4. The NW may indicate to use a third number of feedback bits (e.g., 60 bits) for spatial layer 3 in rank 3 and rank 4. The NW may indicate to use a fourth number of feedback bits (e.g., 90 bits) for spatial layer 4 in rank 4. Alternatively, the NW may indicate the total number of feedback bits and a ratio of allocated bits to the total number of feedback bits for each spatial layer. At block 512 of the method 500, the UE uses a first NN model (NN-1) associated with the first number of feedback bits indicated by the NW for spatial layer 1 (for rank 1, rank 2, rank 3, and rank 4). The UE uses a second NN model (NN-2) associated with the second number of feedback bits indicated by the NW for spatial layer 2 (for rank 2, rank 3, and rank 4). The UE uses a third NN model (NN-3) associated with the third number of feedback bits indicated by the NW for spatial layer 3 (for rank 3 and rank 4). The UE uses a fourth NN model (NN-4) associated with the fourth number of feedback bits indicated by the NW for spatial layer 4 (for rank 4).

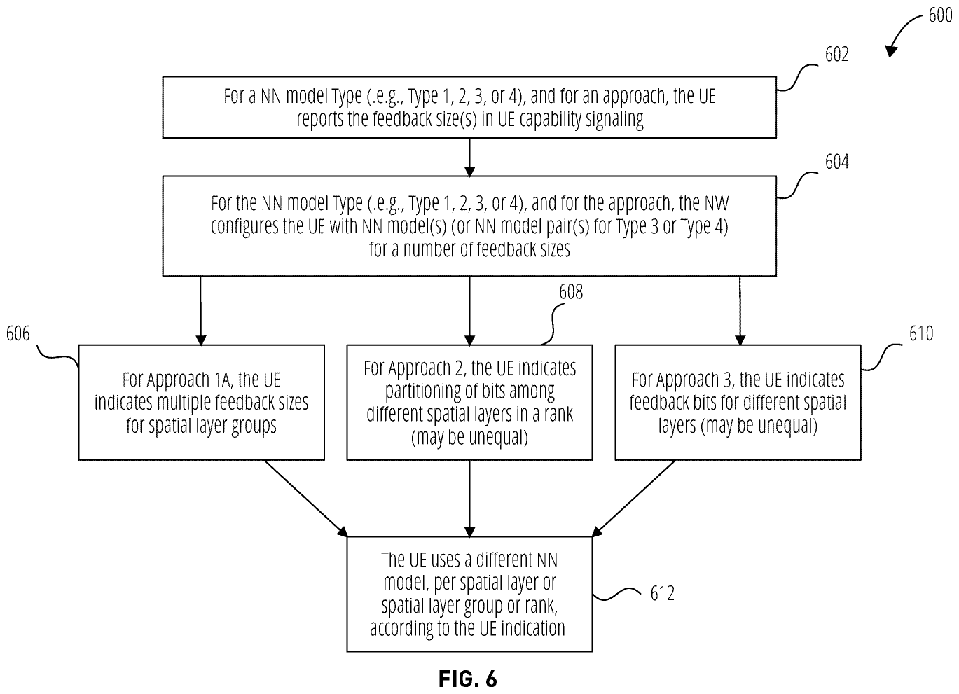

FIG. 6 is a flowchart of a method 600 for overhead allocation for ML based CSI feedback according to another embodiment. The method 600 shown in FIG. 6 is similar to the method 500 shown in FIG. 5, except in the method 600 the UE determines and indicates the overhead allocation to the NW.

At block 602, for a NN model Type (.e.g., Type 1, 2, 3, or 4), and for an approach, the UE reports preferred or capable feedback size(s) in UE capability signaling. At block 604, for the NN model Type (.e.g., Type 1, 2, 3, or 4), and for the approach, the NW configures the UE with NN model(s) (or NN model pair(s) for Type 3 or Type 4) for a number of feedback sizes according to the reported feedback size(s) from the UE. In block 606, block 608, or block 610, depending on the approach, the UE determines and indicates the overhead allocation to the base station. In block 612, the UE uses a different NN model, per spatial layer or spatial layer group or rank, according to the UE indication of the overhead allocation provided to the base station. FIG. 6 shows example UE indications for Approach 1A (block 606), Approach 2 (block 608), and Approach 3 (block 610). However, the disclosure is not so limited, and UE indications may also be applied to other approaches to derive CSI for multiple rank CSI feedback.

As shown in block 606, when the approach comprises Approach 1A discussed above, the UE indicates multiple feedback sizes for spatial layer groups. Referring to FIG. 4B, the UE may indicate a first feedback size for a first spatial layer group that includes spatial layer 1 and spatial layer 2, and the UE may indicate a second feedback size for a second spatial layer group that includes spatial layer 3 and spatial layer 4. Alternatively, the UE may indicate the total feedback size and a ratio of the total for each spatial layer group. At block 612 of the method 600, the UE uses a first NN model (NN-1) associated with the first feedback size indicated to the NW for spatial layer 1 (for rank 1, rank 2, rank 3, and rank 4) and spatial layer 2 (for rank 2, rank 3, and rank4). The UE uses a second NN model (NN-2) associated with the second feedback size indicated to the NW for spatial layer 3 (for rank 3 and rank 4) and spatial layer 4 (for rank 4).

As shown in block 608, when the approach comprises Approach 2 discussed above, the UE indicates partitioning of bits among different spatial layers in a rank (wherein the partitioning may be unequal). Referring to Approach 2 shown in FIG. 4A, for example, the UE may indicate using a first number of feedback bits (e.g., 30 bits) for spatial layer 1 in rank 1. For rank 2, the UE may indicate using a second number of feedback bits (e.g., 60 bits) partitioned between spatial layer 1 and spatial layer 2. For rank 3, the UE may indicate using a third number of feedback bits (e.g., 120 bits) partitioned between spatial layer 1, spatial layer 2, and spatial layer 3 in rank 3. By way of example, for rank 3, the UE may indicate using 30 bits for each of spatial layer 1 and spatial layer 2 and 60 bits for spatial layer 3. For rank 4, the UE may indicate using a fourth number of feedback bits (e.g., 240 bits) partitioned between spatial layer 1, spatial layer 2, spatial layer 3, and spatial layer 4. By way of example, for rank 4, the UE may indicate using 30 bits for each of spatial layer 1 and spatial layer 2, 60 bits for spatial layer 3, and 120 bits for spatial layer 4. Skilled persons will recognize from the disclosure herein, however, that any partitioning may be used for rank 2, rank 3, or rank 4. including equal partitioning among the spatial layers. Alternatively, the UE may indicate the total number of feedback bits and a ratio of the total for each spatial layer. At block 612 of the method 600, the UE uses a first NN model (NN-1) associated with the first number of feedback bits indicated to the NW for rank 1 (spatial layer 1), a second NN model (NN-2) associated with the second number of feedback bits indicated by to NW for rank 2 (spatial layer 1 and spatial layer 2), a third NN model (NN-3) associated with the third number of feedback bits indicated to the NW for rank 3 (spatial layer 1, spatial layer 2, and spatial layer 3), and a fourth NN model (NN-4) associated with the fourth number of feedback bits indicated to the NW for rank 4 (spatial layer 1, spatial layer 2, spatial layer 3, and spatial layer 4).

As shown in block 610, when the approach comprises Approach 3 discussed above, the UE indicates feedback bits for different spatial layers (wherein the number of feedback bits per spatial layer may be unequal). Referring to Approach 3 shown in FIG. 4A, for example, the UE may indicate using a first number of feedback bits (e.g., 30 bits) for spatial layer 1 in rank 1, rank 2, rank 3, and rank 4. The UE may indicate using a second number of feedback bits (e.g., 30 bits) for spatial layer 2 in rank 2, rank 3, and rank 4. The UE may indicate using a third number of feedback bits (e.g., 60 bits) for spatial layer 3 in rank 3 and rank 4. The UE may indicate using a fourth number of feedback bits (e.g., 90 bits) for spatial layer 4 in rank 4. Alternatively, the UE may indicate the total number of feedback bits and a ratio of the total for each spatial layer. At block 612 of the method 600, the UE uses a first NN model (NN-1) associated with the first number of feedback bits indicated to the NW for spatial layer 1 (for rank 1, rank 2. rank 3, and rank 4). The UE uses a second NN model (NN-2) associated with the second number of feedback bits indicated to the NW for spatial layer 2 (for rank 2, rank 3, and rank 4). The UE uses a third NN model (NN-3) associated with the third number of feedback bits indicated to the NW for spatial layer 3 (for rank 3 and rank 4). The UE uses a fourth NN model (NN-4) associated with the fourth number of feedback bits indicated to the NW for spatial layer 4 (for rank 4).

### Enabling Differentiated Feedback Overhead

In certain embodiments, using different feedback overhead (e.g., per rank, per spatial layer, or per spatial layer group) is triggered in response to a predetermined condition, threshold, or formula. For example, it may be triggered when the total feedback overhead is low. With reference to FIG. 2, it can be seen that when the total feedback overhead is large (e.g., when using Type II codebook configuration 8 (config-8)), the need for supporting different feedback overhead for different spatial layers may be diminished because the average cosine similarity is relatively high for each of the spatial layers. However, when the total feedback overhead is low (e.g., when using Type II codebook configuration 1 (config-1)), there is a greater need for supporting different feedback overhead for different spatial layers (e.g., more feedback bits may be used for spatial layer 3 and spatial layer 4 to increase the average cosine similarity for these layers). Thus, the NW or the UE may trigger using different numbers of feedback bits when, for example, the Type II codebook configuration is associated with a relatively low total feedback overhead. In addition, or in other embodiments, the trigger may be in response to determining a low channel quality or low average cosine similarity for one or more spatial layers in comparison to a predetermined threshold value.

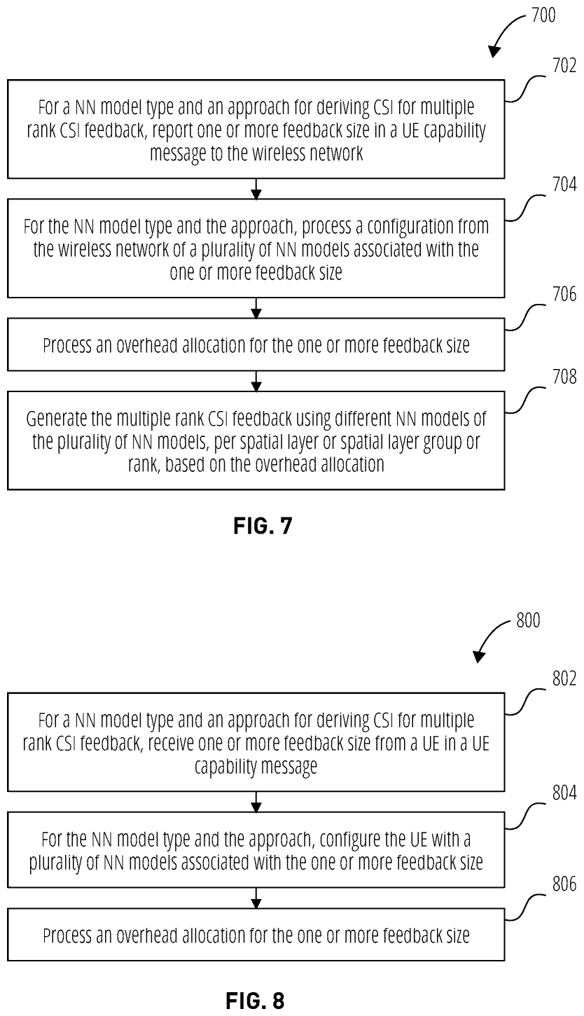

FIG. 7 is a flow chart of a method 700 for a UE to provide ML based CSI feedback to a wireless network according to one embodiment. In block 702, for a NN model type and an approach for deriving CSI for multiple rank CSI feedback, the method 700 includes reporting one or more feedback size in a UE capability message to the wireless network. In certain embodiments, the NN model type and/or the approach are predetermined (e.g., defined in a specification or standard). In other embodiment, the UE and/or the network may selectively choose from among a plurality of different NN model types and/or approaches. In block 704, for the NN model type and the approach, the method 700 includes processing a configuration from the wireless network of a plurality of NN models associated with the one or more feedback size. In block 706, the method 700 includes processing an overhead allocation for the one or more feedback size. In block 708, the method 700 includes generating the multiple rank CSI feedback using different NN models of the plurality of NN models, per spatial layer or spatial layer group or rank, based on the overhead allocation.

In certain embodiments of the method 700, processing the overhead allocation comprises receiving, from the wireless network, an indication of the overhead allocation.

In certain embodiments of the method 700, processing the overhead allocation comprises: determining, at the UE, the overhead allocation based on the plurality of NN models configured by the wireless network for the one or more feedback size; and sending, from the UE to the wireless network, an indication of the overhead allocation.

In certain embodiments of the method 700, the one or more feedback size is selected from a group comprising at least one of a total feedback size, a per spatial layer feedback size, a per spatial layer group feedback size, a per rank feedback size, and a per NN model feedback size.

In certain embodiments of the method 700, the approach comprises using spatial layer group common NN models, and the overhead allocation comprises an indication of: different feedback sizes for different spatial layer groups; or a total feedback size and a ratio of an allocated feedback size to the total feedback size for each of the different spatial layer groups. Generating the multiple rank CSI feedback using the different NN models may include using at least: a first NN model associated with a first feedback size for a first spatial layer group; and a second NN model associated with a second feedback size for a second spatial layer group.

In certain embodiments of the method 700, the approach comprises using rank-specific NN models, and wherein the overhead allocation comprises an indication of: a partitioning of feedback bits among different spatial layers in an indicated rank; or a total number of feedback bits and a ratio of allocated bits to the total number of feedback bits for each of the different spatial layers in the indicated rank. In one such embodiment, the partitioning comprises an unequal number of the feedback bits between the different spatial layers in the indicated rank. In addition, or in other embodiments, generating the multiple rank CSI feedback using the different NN models comprises using two or more of: a first NN model associated with a first number of feedback bits for a first rank; a second NN model associated with a second number of feedback bits partitioned among the different spatial layers for a second rank; a third NN model associated with a third number of feedback bits partitioned among the different spatial layers for a third rank; and a fourth NN model associated with a fourth number of feedback bits partitioned among the different spatial layers for a fourth rank.

In certain embodiments of the method 700, the approach comprises using spatial layer specific NN models, and wherein the overhead allocation comprises an indication of: a number of feedback bits for different spatial layers; or a total number of feedback bits and a ratio of allocated bits to the total number of feedback bits for each of the different spatial layers. In one such embodiment, the indication indicates an unequal number of the number of feedback bits between the different spatial layers. In addition, or in other embodiments, generating the multiple rank CSI feedback using the different NN models comprises using two or more of: a first NN model associated with a first number of feedback bits for a first spatial layer; a second NN model associated with a second number of feedback bits for a second spatial layer; a third NN model associated with a third number of feedback bits for a third spatial layer; and a fourth NN model associated with a fourth number of feedback bits for a fourth spatial layer.

In certain embodiments of the method 700, the NN model type is optimized for UE hardware and base station hardware separately, and the plurality of NN models each comprise an NN model pair corresponding to an encoder at the UE and a decoder at the base station.

In certain embodiments, the method 700 further includes: determining a total feedback overhead for a codebook configuration; comparing the total feedback overhead to a threshold value to determine a trigger event; and in response to the trigger event, processing the overhead allocation and generating the multiple rank CSI feedback using the different NN based on the overhead allocation.

Embodiments contemplated herein include an apparatus comprising means to perform one or more elements of the method 700. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 700. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a UE (such as a wireless device 1002 that is a UE, as described herein).

Embodiments contemplated herein include a signal as described in or related to one or more elements of the method 700.

Embodiments contemplated herein include a computer program or computer program product comprising instructions, wherein execution of the program by a processor is to cause the processor to carry out one or more elements of the method 700. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

FIG. 8 is a flowchart of a method 800 for a base station to configure ML based CSI feedback in a wireless network according to one embodiment. In block 802, for a NN model type and an approach for deriving CSI for multiple rank CSI feedback, the method 800 includes receiving one or more feedback size from a user equipment (UE) in a UE capability message. In certain embodiments, the NN model type and/or the approach are predetermined (e.g., defined in a specification or standard). In other embodiment, the UE and/or the network may selectively choose from among a plurality of different NN model types and/or approaches. In block 804, for the NN model type and the approach, the method 800 includes configuring the UE with a plurality of NN models associated with the one or more feedback size. In block 806, the method 800 includes processing an overhead allocation for the one or more feedback size.

In one embodiment of the method 800, processing the overhead allocation comprises receiving, at the base station from the UE, an indication of the overhead allocation.

In one embodiment of the method 800, processing the overhead allocation comprises: determining, at the base station, the overhead allocation based on the plurality of NN models configured by the wireless network for the one or more feedback size; and sending, from the base station to the UE, an indication of the overhead allocation.

In one embodiment of the method 800, the one or more feedback size is selected from a group comprising at least one of a total feedback size, a per spatial layer feedback size, a per spatial layer group feedback size, a per rank feedback size, and a per NN model feedback size.

In one embodiment of the method 800, the approach comprises using spatial layer group common NN models, and the overhead allocation comprises an indication of: different feedback sizes for different spatial layer groups; or a total feedback size and a ratio of an allocated feedback size to the total feedback size for each of the different spatial layer groups.

In one embodiment of the method 800, the approach comprises using rank-specific NN models, and wherein the overhead allocation comprises an indication of: a partitioning of feedback bits among different spatial layers in an indicated rank; or a total number of feedback bits and a ratio of allocated bits to the total number of feedback bits for each of the different spatial layers in the indicated rank. In one such embodiment, the partitioning comprises an unequal number of the feedback bits between the different spatial layers in the indicated rank.

In one embodiment of the method 800, the approach comprises using spatial layer specific NN models, and wherein the overhead allocation comprises an indication of: a number of feedback bits for different spatial layers; or a total number of feedback bits and a ratio of allocated bits to the total number of feedback bits for each of the different spatial layers. In one such embodiment, the indication indicates an unequal number of the number of feedback bits between the different spatial layers.

In one embodiment of the method 800, the NN model type is optimized for UE hardware and base station hardware separately, and the plurality of NN models each comprise an NN model pair corresponding to an encoder at the UE and a decoder at the base station.

In one embodiment, the method 800 further includes: determining a total feedback overhead for a codebook configuration; comparing the total feedback overhead to a threshold value to determine a trigger event; and in response to the trigger event, processing the overhead allocation.

Embodiments contemplated herein include an apparatus comprising means to perform one or more elements of the method 800. This apparatus may be, for example, an apparatus of a base station (such as a network device 1018 that is a base station, as described herein)

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a base station (such as a memory 1022 of a network device 1018 that is a base station, as described herein).

Embodiments contemplated herein include an apparatus comprising logic, modules, or circuitry to perform one or more elements of the method 800. This apparatus may be, for example, an apparatus of a base station (such as a network device 1018 that is a base station, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a base station (such as a network device 1018 that is a base station, as described herein).

Embodiments contemplated herein include a signal as described in or related to one or more elements of the method 800.

Embodiments contemplated herein include a computer program or computer program product comprising instructions, wherein execution of the program by a processing element is to cause the processing element to carry out one or more elements of the method 800. The processor may be a processor of a base station (such as a processor(s) 1020 of a network device 1018 that is a base station, as described herein). These instructions may be, for example, located in the processor and/or on a memory of the base station (such as a memory 1022 of a network device 1018 that is a base station, as described herein).

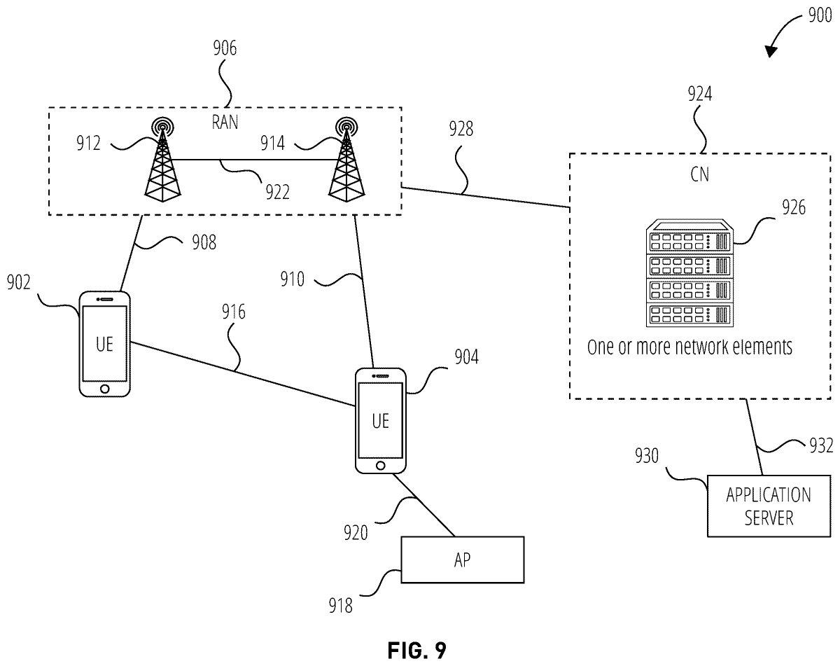

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations (such as base station 912 and base station 914) that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VoIP sessions, group communication sessions, etc.) for the UE 902 and UE 904 via the CN 924. The application server 930 may communicate with the CN 924 through an IP communications interface 932.

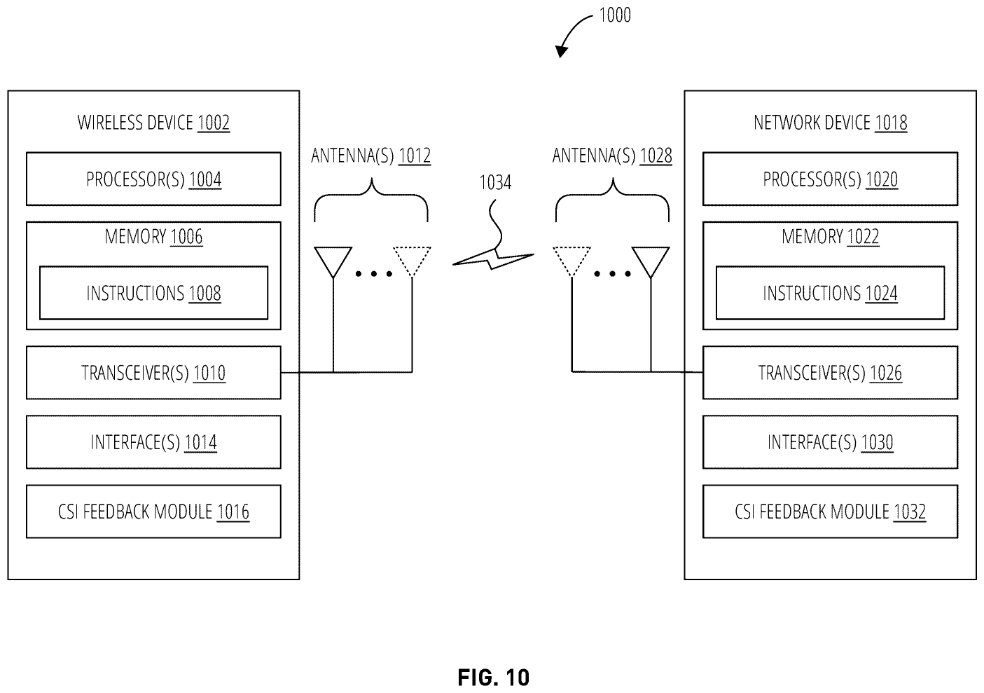

FIG. 10 illustrates a system 1000 for performing signaling 1034 between a wireless device 1002 and a network device 1018, according to embodiments disclosed herein. The system 1000 may be a portion of a wireless communications system as herein described. The wireless device 1002 may be, for example, a UE of a wireless communication system. The network device 1018 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1034) to and/or from the wireless device 1002 with other devices (e.g., the network device 1018) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include a CSI feedback module 1016. The CSI feedback module 1016 may be implemented via hardware, software, or combinations thereof. For example, the CSI feedback module 1016 may be implemented as a processor, circuit, and/or instructions 1008 stored in the memory 1006 and executed by the processor(s) 1004. In some examples, the CSI feedback module 1016 may be integrated within the processor(s) 1004 and/or the transceiver(s) 1010. For example, the CSI feedback module 1016 may be implemented by a combination of software components (e.g., executed by a DSP or a general processor) and hardware components (e.g., logic gates and circuitry) within the processor(s) 1004 or the transceiver(s) 1010.

The CSI feedback module 1016 may be used for various aspects of the present disclosure, for example, aspects of FIG. 5, FIG. 6, and FIG. 7. Further, the CSI feedback module 1016 may include an encoder, such as the encoder 102 shown in FIG. 1.

The network device 1018 may include one or more processor(s) 1020. The processor(s) 1020 may execute instructions such that various operations of the network device 1018 are performed, as described herein. The processor(s) 1020 may include one or more baseband processors implemented using, for example, a CPU, a DSP, an ASIC, a controller, an FPGA device, another hardware device, a firmware device, or any combination thereof configured to perform the operations described herein.

The network device 1018 may include a memory 1022. The memory 1022 may be a non-transitory computer-readable storage medium that stores instructions 1024 (which may include, for example, the instructions being executed by the processor(s) 1020). The instructions 1024 may also be referred to as program code or a computer program. The memory 1022 may also store data used by, and results computed by, the processor(s) 1020.

The network device 1018 may include one or more transceiver(s) 1026 that may include RF transmitter and/or receiver circuitry that use the antenna(s) 1028 of the network device 1018 to facilitate signaling (e.g., the signaling 1034) to and/or from the network device 1018 with other devices (e.g., the wireless device 1002) according to corresponding RATs.

The network device 1018 may include one or more antenna(s) 1028 (e.g., one, two, four, or more). In embodiments having multiple antenna(s) 1028, the network device 1018 may perform MIMO, digital beamforming, analog beamforming, beam steering, etc., as has been described.

The network device 1018 may include one or more interface(s) 1030. The interface(s) 1030 may be used to provide input to or output from the network device 1018. For example, a network device 1018 that is a base station may include interface(s) 1030 made up of transmitters, receivers, and other circuitry (e.g., other than the transceiver(s) 1026/antenna(s) 1028 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1018 may include a CSI feedback module 1032. The CSI feedback module 1032 may be implemented via hardware, software, or combinations thereof. For example, the CSI feedback module 1032 may be implemented as a processor, circuit, and/or instructions 1024 stored in the memory 1022 and executed by the processor(s) 1020. In some examples, the CSI feedback module 1032 may be integrated within the processor(s) 1020 and/or the transceiver(s) 1026. For example, the CSI feedback module 1032 may be implemented by a combination of software components (e.g., executed by a DSP or a general processor) and hardware components (e.g., logic gates and circuitry) within the processor(s) 1020 or the transceiver(s) 1026.

The CSI feedback module 1032 may be used for various aspects of the present disclosure, for example, aspects of FIG. 5, FIG. 6, and FIG. 8. Further, the CSI feedback module 1032 may include a decoder, such as the decoder 104 shown in FIG. 1.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE) to provide machine learning (ML) based channel state information (CSI) feedback to a wireless network, the method comprising:
for a neural network (NN) model type and an approach for deriving CSI for multiple rank CSI feedback, reporting one or more feedback size in a UE capability message to the wireless network;
for the NN model type and the approach, processing a configuration from the wireless network of a plurality of NN models associated with the one or more feedback size;
processing an overhead allocation for the one or more feedback size; and
generating the multiple rank CSI feedback using different NN models of the plurality of NN models, per spatial layer or spatial layer group or rank, based on the overhead allocation.

2. The method of claim 1, wherein processing the overhead allocation comprises receiving, from the wireless network, an indication of the overhead allocation.

3. The method of claim 1, wherein processing the overhead allocation comprises:
determining, at the UE, the overhead allocation based on the plurality of NN models configured by the wireless network for the one or more feedback size; and
sending, from the UE to the wireless network, an indication of the overhead allocation.

4. The method of claim 1, wherein the one or more feedback size is selected from a group comprising at least one of a total feedback size, a per spatial layer feedback size, a per spatial layer group feedback size, a per rank feedback size, and a per NN model feedback size.

5. The method of claim 1, wherein the approach comprises using spatial layer group common NN models, and wherein the overhead allocation comprises an indication of:
different feedback sizes for different spatial layer groups; or
a total feedback size and a ratio of an allocated feedback size to the total feedback size for each of the different spatial layer groups.

6. The method of claim 5, wherein generating the multiple rank CSI feedback using the different NN models comprises using at least:
a first NN model associated with a first feedback size for a first spatial layer group; and
a second NN model associated with a second feedback size for a second spatial layer group.

7. The method of claim 1, wherein the approach comprises using rank-specific NN models, and wherein the overhead allocation comprises an indication of:
a partitioning of feedback bits among different spatial layers in an indicated rank; or
a total number of feedback bits and a ratio of allocated bits to the total number of feedback bits for each of the different spatial layers in the indicated rank.

8. The method of claim 7, wherein the partitioning comprises an unequal number of the feedback bits between the different spatial layers in the indicated rank.

9. The method of claim 7, wherein generating the multiple rank CSI feedback using the different NN models comprises using two or more of:
a first NN model associated with a first number of feedback bits for a first rank;
a second NN model associated with a second number of feedback bits partitioned among the different spatial layers for a second rank;
a third NN model associated with a third number of feedback bits partitioned among the different spatial layers for a third rank; and
a fourth NN model associated with a fourth number of feedback bits partitioned among the different spatial layers for a fourth rank.

10. The method of claim 1, wherein the approach comprises using spatial layer specific NN models, and wherein the overhead allocation comprises an indication of:
a number of feedback bits for different spatial layers; or
a total number of feedback bits and a ratio of allocated bits to the total number of feedback bits for each of the different spatial layers.

11. The method of claim 10, wherein the indication indicates an unequal number of the number of feedback bits between the different spatial layers.

12. The method of claim 10, wherein generating the multiple rank CSI feedback using the different NN models comprises using two or more of:
a first NN model associated with a first number of feedback bits for a first spatial layer;
a second NN model associated with a second number of feedback bits for a second spatial layer;
a third NN model associated with a third number of feedback bits for a third spatial layer; and
a fourth NN model associated with a fourth number of feedback bits for a fourth spatial layer.

13. The method of claim 1, wherein the NN model type is optimized for UE hardware and base station hardware separately, and wherein the plurality of NN models each comprise an NN model pair corresponding to an encoder at the UE and a decoder at the base station.

14. The method of claim 1, further comprising:
determining a total feedback overhead for a codebook configuration;
comparing the total feedback overhead to a threshold value to determine a trigger event; and
in response to the trigger event, processing the overhead allocation and generating the multiple rank CSI feedback using the different NN based on the overhead allocation.

15. A method for a base station to configure machine learning (ML) based channel state information (CSI) feedback in a wireless network, the method comprising:
for a neural network (NN) model type and an approach for deriving CSI for multiple rank CSI feedback, receiving one or more feedback size from a user equipment (UE) in a UE capability message;
for the NN model type and the approach, configuring the UE with a plurality of NN models associated with the one or more feedback size; and
processing an overhead allocation for the one or more feedback size.

16. The method of claim 15, wherein processing the overhead allocation comprises receiving, at the base station from the UE, an indication of the overhead allocation.

17. The method of claim 15, wherein processing the overhead allocation comprises:
determining, at the base station, the overhead allocation based on the plurality of NN models configured by the wireless network for the one or more feedback size; and
sending, from the base station to the UE, an indication of the overhead allocation.

18. The method of claim 15, wherein the one or more feedback size is selected from a group comprising at least one of a total feedback size, a per spatial layer feedback size, a per spatial layer group feedback size, a per rank feedback size, and a per NN model feedback size.

19. The method of claim 15, wherein the approach comprises using spatial layer group common NN models, and wherein the overhead allocation comprises an indication of:
different feedback sizes for different spatial layer groups; or
a total feedback size and a ratio of an allocated feedback size to the total feedback size for each of the different spatial layer groups.

20. The method of claim 15, wherein the approach comprises using rank-specific NN models, and wherein the overhead allocation comprises an indication of:
a partitioning of feedback bits among different spatial layers in an indicated rank; or
a total number of feedback bits and a ratio of allocated bits to the total number of feedback bits for each of the different spatial layers in the indicated rank.

21-28. (canceled)
